(19) United States
(12) Patent Application Publication
(10) Pub. No.: US 2014/0226060 A1
(43) Pub. Date: Aug. 14, 2014

(54) ELECTRONIC DEVICE AND METHOD FOR MANUFACTURING THE SAME

(71) Applicant: HTC CORPORATION, Taoyuan County (TW)

(72) Inventor: Christopher Alan Porter, San Francisco, CA (US)

(73) Assignee: HTC CORPORATION, Taoyuan County (TW)

(21) Appl. No.: 13/762,409

(22) Filed: Feb. 8, 2013

(51) Int. Cl. G02B 1/11; H04N 5/225; C03B 37/012

(52) U.S. Cl. CPC G02B 1/11; C03B 37/01211; H04N 5/2254
USPC 348/373; 65/408; 65/409; 65/411

(57) ABSTRACT

An electronic device includes a housing, a light emitting module, a light sensor and a lens. The light emitting module is disposed inside the housing and configured to emit a light out of the housing. The light sensor is disposed inside the housing and configured to receive an environmental light from outside of the housing. The lens, coupled with the housing, includes a first transparent portion, a second transparent portion and an opaque portion. The first transparent portion allows the light to be emitted out of the housing. The second transparent portion allows the environmental light to pass through, so that the light sensor receives the environmental light. The opaque portion is disposed between the first transparent portion and the second transparent portion. The first transparent portion, the second transparent portion and the opaque portion are integrated into a whole and made of the same material.

### BACKGROUND OF THE INVENTION

1. Field of the Invention

The present invention relates to an electronic device and a method for manufacturing the same, and more particularly, to an electronic device including a lens with light leakage prevention as well as a smooth and single surface that is scratch resistant, and a method for manufacturing the same.

2. Description of the Prior Art

With development of the wireless communication technology, a mobile phone has been widely implemented in people's daily life. Recently, the mobile phone is equipped with a camera module and a flash module. The camera module is used for capturing images, and the flash module is used for providing the camera module with a light source when the light is too dim for the camera module to capture the images.

The mobile phone may further includes a lens which is often disposed on a housing of the mobile phone for protecting the camera module and the flash module. Conventionally, two separate lens components, a camera lens and a flash lens, are used for the camera module and flash module. The camera lens is placed on the housing of the mobile phone to overlay on the camera module, and the flash lens is placed on the housing to overlay on the flash module. The two lens components, the camera lens and the flash lens, are manufactured separately and assembled together on the housing. An ink mask may be printed on surface of the lens for preventing light leakage from the flash module to the camera module. However, the ink mask results in the unsmooth and step surface of the lens. Furthermore, the ink mask is often scratched, resulting in the light leakage, and thus it affects quality of the images captured by the camera module.

### SUMMARY OF THE INVENTION

Thus, the present invention provides an electronic device including a lens with light leakage prevention as well as a smooth and single surface that is scratch resistant, and a method for manufacturing the same for solving above drawbacks.

According to the claimed invention, an electronic device includes a housing, a light emitting module, a light sensor and a lens. The light emitting module is disposed inside the housing and configured to generate and emit a light out of the housing. The light sensor is disposed inside the housing and configured to receive an environmental light outside the housing, and the lens is coupled with the housing. The lens includes a first transparent portion through which the light passes and is emitted out of the housing, a second transparent portion through which the environmental light outside the housing passes and is received by the light sensor and an opaque portion disposed between the first transparent portion and the second transparent portion. The first transparent portion, the second transparent portion and the opaque portion are integrated into a whole and made of the same material.

According to the claimed invention, an opening is formed on the housing, and the lens is disposed in the opening.

According to the claimed invention, an aperture is formed on the housing, and the lens is disposed between the aperture and the light sensor.

According to the claimed invention, the opaque portion is doped with metallic atoms for absorbing the light transmitted to the opaque portion.

According to the claimed invention, the metallic atoms are products of a reduction of a portion of metallic ions doped in the opaque portion.

According to the claimed invention, the metallic atoms are lead atoms.

According to the claimed invention, the opaque portion, the first transparent portion and the second transparent portion are circular structures, a diameter of the second transparent portion is greater than a diameter of the first transparent portion, and the first transparent portion and the second transparent portion are disposed within the opaque portion.

According to the claimed invention, doping percentage of the metallic atoms arranges from 24 percent to 35 percent.

According to the claimed invention, the metallic ions are reduced to metallic atoms in a hydrogen firing process.

According to the claimed invention, the first transparent portion, the second transparent portion and the opaque portion are made of silica materials.

According to the claimed invention, the lens further comprises an anti-reflective coating disposed on the lens.

According to the claimed invention, the anti-reflective coating is disposed between the lens and the light emitting module and the light sensor.

According to the claimed invention, the light sensor is an image sensor.

According to the claimed invention, the first transparent portion overlays the light emitting module, and the second transparent portion overlays the light sensor.

According to the claimed invention, a plurality of leaded glass fibers doped with lead ions is bundled inside a fixture manually, along with unleaded glass fibers. This bundle is then melted and machined.

According to the claimed invention, a method for manufacturing a lens for a light emitting module and a light sensor of an electronic device is disclosed. The method includes bundling a plurality of first glass fibers doped with metallic ions with at least two of second glass fibers to form a bundled glass fiber, heating the bundled glass fiber for forming a glass piece, slicing the glass piece into a plurality of glass disks, disposing the plurality of glass disks in a heating chamber, heating the plurality of glass disks in the heating chamber to reduce the metallic ions in the glass disks to metallic atoms so that the opaque portion with the metallic atoms doped is formed for absorbing a light.

According to the claimed invention, bundling a plurality of first glass fibers doped with metallic ions with at least two of second glass fibers to form a bundled glass fiber further includes providing a hollow cylinder, disposing the plurality of first glass fibers inside the hollow cylinder, and disposing the at least two of second glass fibers inside the hollow cylinder to form the bundled glass fiber.

According to the claimed invention, heating the bundled glass fiber for forming a glass piece further includes melting the bundled glass fiber and drawing the bundled glass fiber for forming the glass piece.

According to the claimed invention, bundling a plurality of first glass fibers doped with metallic ions with at least two of second glass fibers to form a bundled glass fiber further includes providing a container, and disposing the plurality of first glass fibers and at least two of second glass fibers inside the container for forming the bundled glass fiber.

According to the claimed invention, heating the bundled glass fiber for forming a glass piece further includes heating the container, and melting the first glass fibers to form the glass piece.

According to the claimed invention, disposing the plurality of glass disks in a heating chamber further includes placing the glass disks in the heating chamber with a space between the two adjacent glass disks.

According to the claimed invention, heating the plurality of glass disks includes heating the plurality of glass disks at a temperature between 460 degree Celsius and 1600 degree Celsius.

According to the claimed invention, heating the plurality of glass disks includes the plurality of glass disks is heated for at least 8 hours.

According to the claimed invention, heating the plurality of glass disks to reduce the metallic ions in the glass disks to metallic atoms in heating chamber further includes flowing hydrogen gas in the heating chamber.

According to the claimed invention, flow rate of hydrogen gas in the heating chamber is at least 4 cubic feet per hour.

According to the claimed invention, the method further includes polishing the plurality of glass disks after heating the plurality of glass disks in the heating chamber.

According to the claimed invention, the method further includes coating anti-reflective coating on the plurality of glass disks after heating the plurality of glass disks in the heating chamber.

In summary, since the first transparent portion, the second transparent portion and the opaque portion of the lens member are integrally formed by the first glass fibers with metallic ions doped and the second glass fibers in a firing process, the lens of the present invention can have a smooth and single surface. In addition, the metallic ions, i.e. the lead ions, doped in first glass fibers are reduced to the metallic atoms, i.e. the lead atoms, for opaque the light instead of the conventionally printed ink. Thus, it is more scratch resistant, i.e. the lens of present invention provides a lens structure with light leakage prevention as well as a smooth and single surface that is scratch resistant.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention.

FIG. 2 is a partly sectional diagram of the electronic device according to the embodiment of the present invention.

FIG. 3 is a partly sectional diagram of an electronic device according to another embodiment of the present invention.

FIG. 4 is a diagram of a lens member according to the embodiment of the present invention.

FIG. 5 is a flow chart illustrating method for manufacturing the lens member with a first circular portion and a second circular portion of a transparent portion as well as a masking portion according to the embodiment of the present invention.

FIG. 6 to FIG. 11 are respectively a schematic diagram illustrating how to manufacturing the lens member corresponding to the steps shown in FIG. 5.

FIG. 12 to FIG. 14 are respectively a schematic diagram illustrating how to manufacturing the lens member according to another embodiment of the present invention.

### DETAILED DESCRIPTION

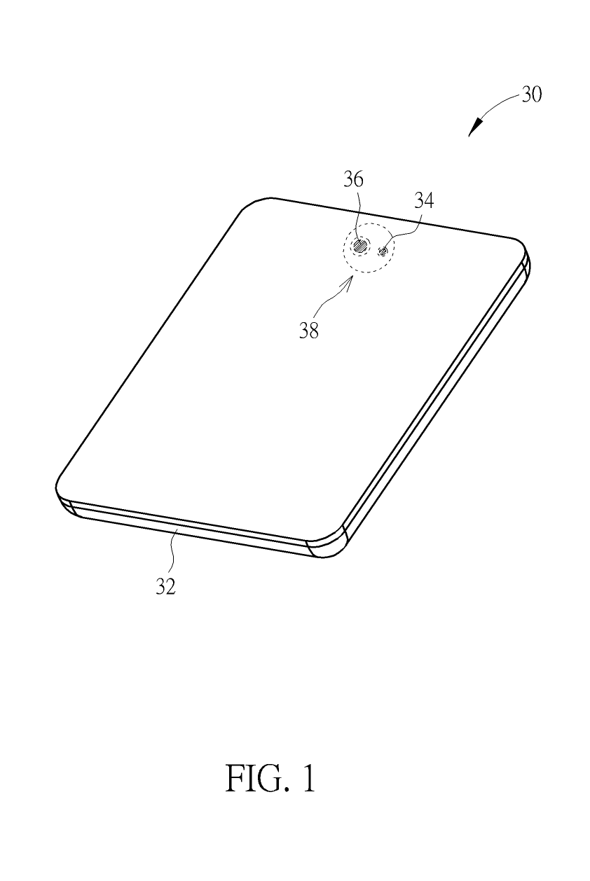

Please refer to FIG. 1. FIG. 1 is a schematic diagram of an electronic device 30 according to an embodiment of the present invention. As shown in FIG. 1, the electronic device 30 includes a housing 32, a light emitting module 34 and a light sensor 36. The light emitting module 34 is disposed inside the housing 32 and configured to generate and emit a light out of the housing 32. The light sensor 36 is disposed inside the housing 32 and configured to receive an environmental light outside the housing 32. The light emitting module 34 may be a flash light, a light emitting diode or a camera flash light. The light sensor 36 may be an image sensor, a camera or any device capable of sensing an incident light.

In this embodiment, the electronic device 30 is a handheld device, such as a mobile phone, a PDA, a smart phone or accessory that a user may carry with such as a necklace, or a ring. Implementation of the electronic device 30 is not limited to those mentioned in this embodiment. For example, the electronic device 30 can be a portable electronic device, such as a tablet computer, a notebook computer and so on. As for which one of the aforesaid designs is adopted, it depends on practical demands. Furthermore, the electronic device 30 further includes a lens 38 coupled with the housing 32. The lens 38 covers the light emitting module 34 and the light sensor 36, so as to prevent the light emitting module 34 and the light sensor 36 from damages due to collision, scratch and so on.

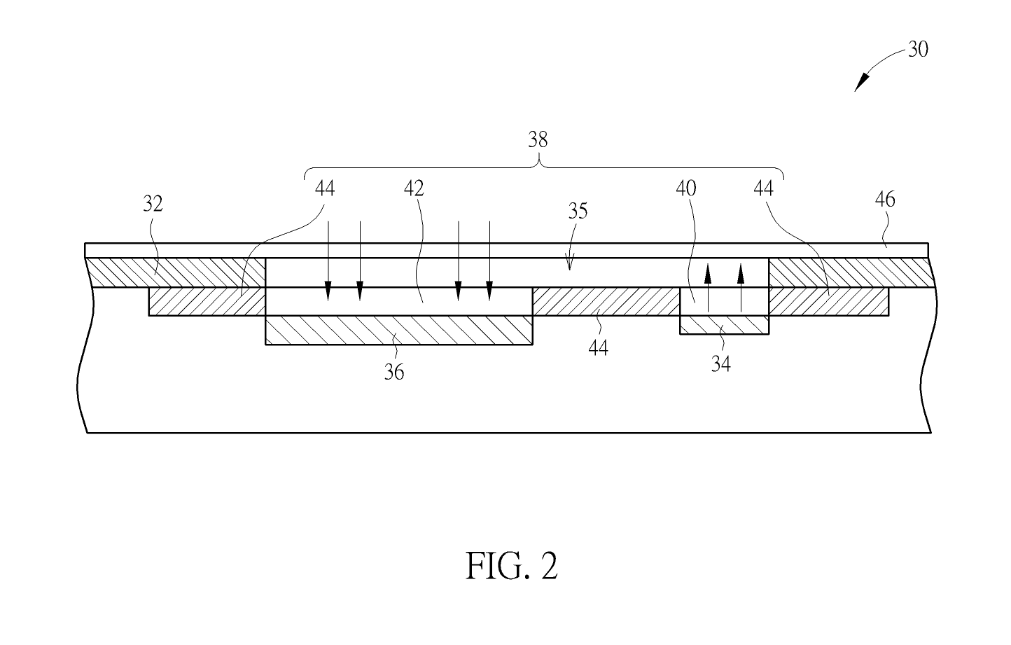

Please refer to FIG. 1 and FIG. 2. FIG. 2 is a partly sectional diagram of the electronic device 30 according to the embodiment of the present invention. As shown in FIG. 1 and FIG. 2, the lens 38 includes a first transparent portion 40 through which the light passes and is emitted out of the housing 32. In other words, the light generated by the light emitting module 34 is capable of emitting out of the housing 32 via the first transparent portion 40. Furthermore, The lens 38 further includes a second transparent portion 42 through which the environmental light outside the housing 32 passes and is received by the light sensor 36 and an opaque portion 44 between the first transparent portion 40. In other words, the light sensor 36 is capable of receiving the environmental light outside the housing 32 via the second transparent portion 42. In summary, the light sensor 36 can capture the images via the second transparent portion 42, and further the light emitted from the light emitting module 34 can pass through the first transparent portion 40.

Furthermore, the lens 38 further includes an opaque portion 44 disposed between the first transparent portion 40 and the second transparent portion 42. The opaque portion 44 is used for covering a periphery of the light emitting module 34 and the light sensor 36. In addition, the opaque portion 44 may be further used for masking the light emitted from the light emitting module 34, so as to prevent light leakage from the light emitting module 34 and further to keep image quality of the light sensor 36. In this embodiment, the first transparent portion 40, the second transparent portion 42 and the opaque portion 44 are integrated into a whole and made of the same material. Practically, the first transparent portion 40, the second transparent portion 42 and the opaque portion 44 may be made of silica materials.

As shown in FIG. 2, an aperture 35 may be formed on the surface of the housing 32 and the lens 38 is disposed between the aperture 35 and the light sensor 36. The first transparent portion 40 may overlay the light emitting module 34, and the second transparent portion 42 may overlay the image sensor 36. The light emitting module 34 may couple to the first transparent portion 40 through a first light guide, and the light sensor 36 may couple to the second transparent portion 42 through a second light guide.

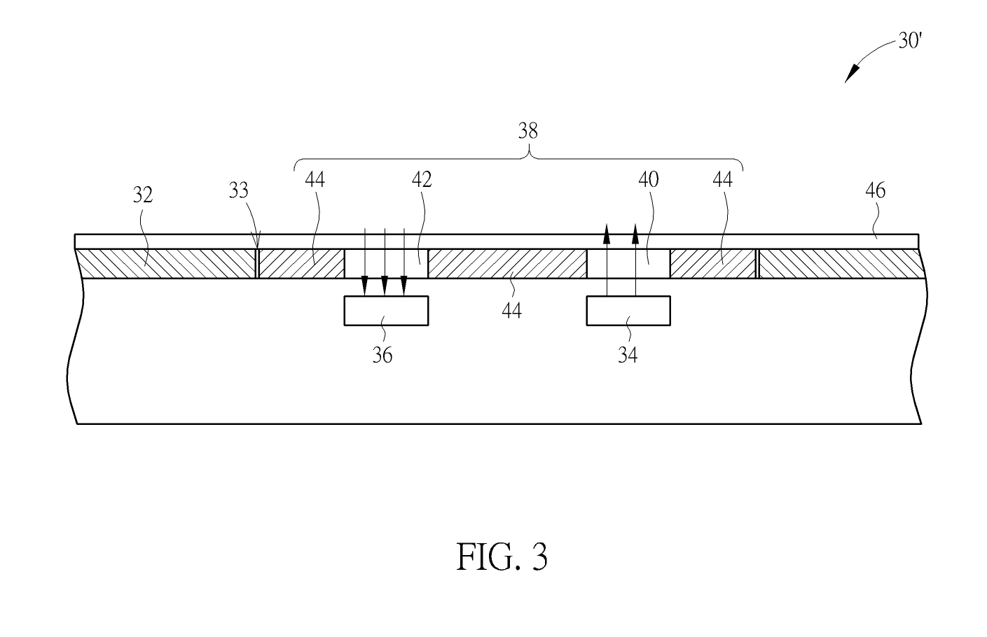

It should be noticed that the light senor 36 and the light emitting module 34 may not need to be placed directly below the second transparent portion 42 or first transparent portion 40, respectively. For example, please refer to FIG. 3. FIG. 3 is a partly sectional diagram of an electronic device 30′ according to another embodiment of the present invention. As shown in FIG. 3, an opening 33 may be formed on the surface of the housing 32′ and the lens 38 is disposed in the opening 33. As for which one of the aforesaid designs is adopted, it depends on practical demands.

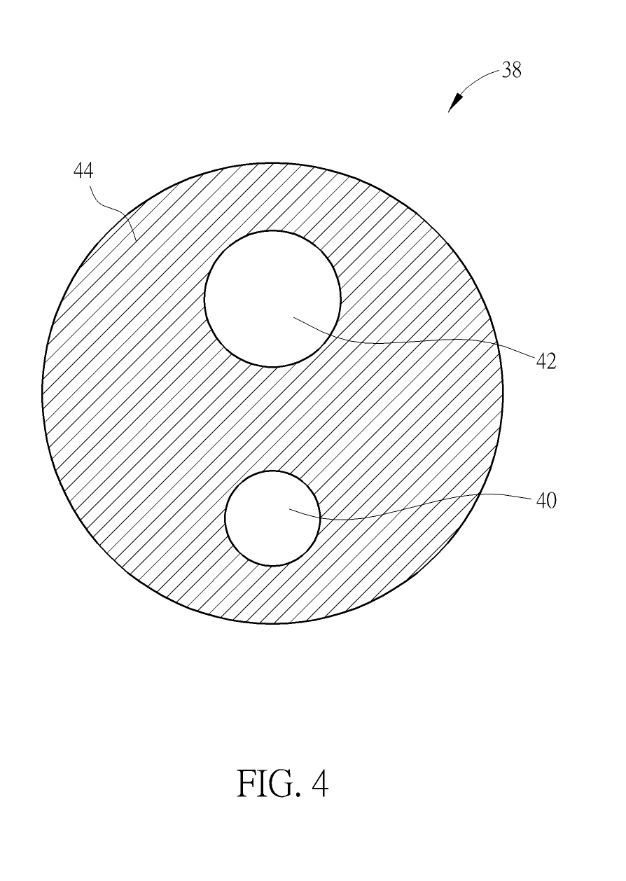

Please refer to FIG. 4. FIG. 4 is a diagram of the lens 38 according to the embodiment of the present invention. As shown in FIG. 4, the opaque portion 44, the first transparent portion 40 and the second transparent portion 42 of the lens 38 are respectively a circular structure. The diameter of the second transparent portion 42 is greater than a diameter of the first transparent portion 40. The first transparent portion 40 and the second transparent 42 portion are disposed within the opaque portion 44. In other words, the opaque portion 44 is greater than the first transparent portion 40 and the second transparent portion 42.

As mentioned above, the lens 38 is in a substantially circular shape, and design for shape of the lens 38 is not limited to those mentioned in this embodiment. For example, the lens 38 can be in an elliptic or in a slot shape in consideration of limitation of mechanically inner space of the electronic device 30. In other words, the shape of the lens 38 can be designed according to practical mechanism of the electronic device 30. As for which one of the aforesaid designs is adopted, it depends on practical demands. In addition, the opaque portion 44 is doped with metallic ions. Practically, the opaque portion 44 of the lens 38 is fired to make the metallic ions doped inside the opaque portion 44 be reduced to metallic atoms, so that the reduced metallic atoms is capable of opaque the opaque portion 44. In other words, the opaque portion 44 is fired to make the opaque portion 44 be doped with the metallic atoms, i.e. the metallic atoms are products of a reduction of a portion of the metallic ions in the opaque portion 44 to the atomic state. Therefore, the light transmitted through the opaque portion 44 toward the second transparent portion 42 may be absorbed by the metallic atoms.

In other words, the metallic ions doped in the opaque portion 44 can be reduced to the metallic atoms in a firing process, so that the reduced metallic atoms may turn the opaque portion 44 to be opaque for absorbing the light from the first transparent portion 40 and the second transparent portion 42. The firing process may be a hydrogen firing process which reduces the metallic ions, such as the lead ions, to the metallic atoms, such as the lead atoms. Accordingly, the opaque portion 44 can be used for absorbing the light emitted from the light emitting module 34 and reflected by the surfaces of the lens 38, so as to prevent the light leakage from the light emitting module 34 and further to keep image quality of the image captured by the light sensor 36.

Furthermore, the lens 38 may further comprise an anti-reflective coating 46 disposed on the lens 38. The anti-reflective coating 46 is disposed between the lens 38 and the light emitting module 34 and the light sensor 36. Practically, the anti-reflective coating 46 is used for eliminating reflection of light, so that the light can pass through the second transparent portion 42 without reflection for enhance amount of the light received by the light sensor 36. Accordingly, it can enhance the image quality of the image captured by the light sensor 36.

In manufacturing perspective, at first, the first transparent portion 40 and the second transparent portion 42, which are used for covering, overlaying or coupling with the light sensor 36 and the light emitting module 34, are formed with the opaque portion 44, which is used for covering the periphery of the light emitting module 34 and the light sensor 36. Then, the metallic ions doped in the opaque portion 44 are reduced to the metallic atoms in a firing process, so as to opaque the opaque portion 44. As a result, the lens 38 with the opaque portion 44 for absorbing the light can be formed. In this embodiment, the first transparent portion 40 and the second transparent portion 42 as well as the opaque portion 44 are made of silica materials, i.e. glass or silica materials, and the metallic ions doped in the opaque portion 44 are lead ions. In other words, the opaque portion 44 is made of leaded glass materials, and the first transparent portion 40 and the transparent circular portion 42 are made of non-leaded glass materials.

In other words, the metallic atoms doped in the opaque portion 44 are lead atoms, and the lead atoms are formed from firing of the lead ions doped inside the opaque portion 44, wherein the firing process turns the lead ions to the lead atoms. In this embodiment, doping percentage of the metallic ions such as lead ions arranges, but not limited to, from 24 percent to 35 percent. Practically, the metallic ions can be reduced to metallic atoms in a hydrogen firing process. Implementation of the metallic ions is not limited to those mentioned in this embodiment. In other words, the metallic ions capable of being doped in the glass materials and being reduced to the metallic atoms to opaque the opaque portion 44 are within the scope of the present invention. Hereinafter the lead ions are illustrated in the embodiment and descriptions for other metallic ions are omitted for simplicity due to the identical principles.

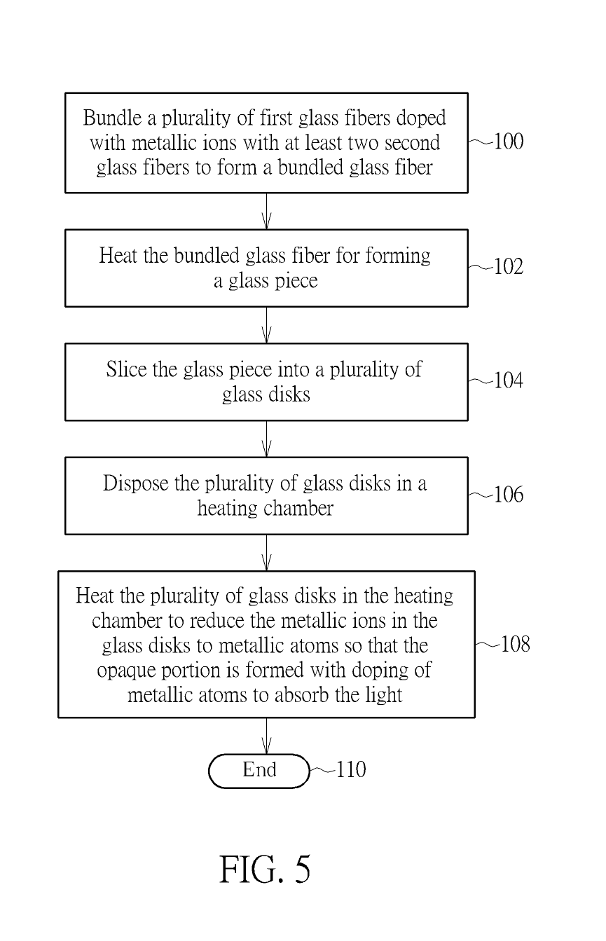

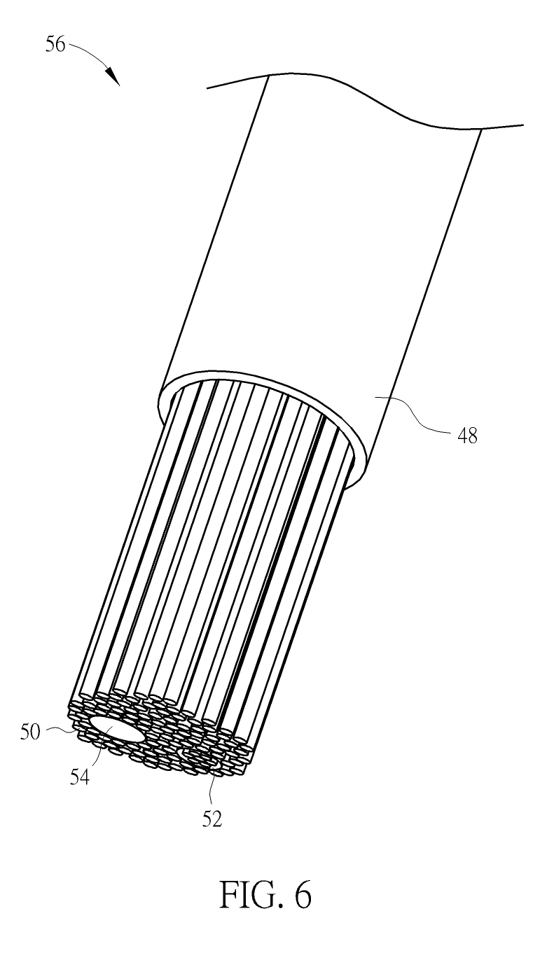

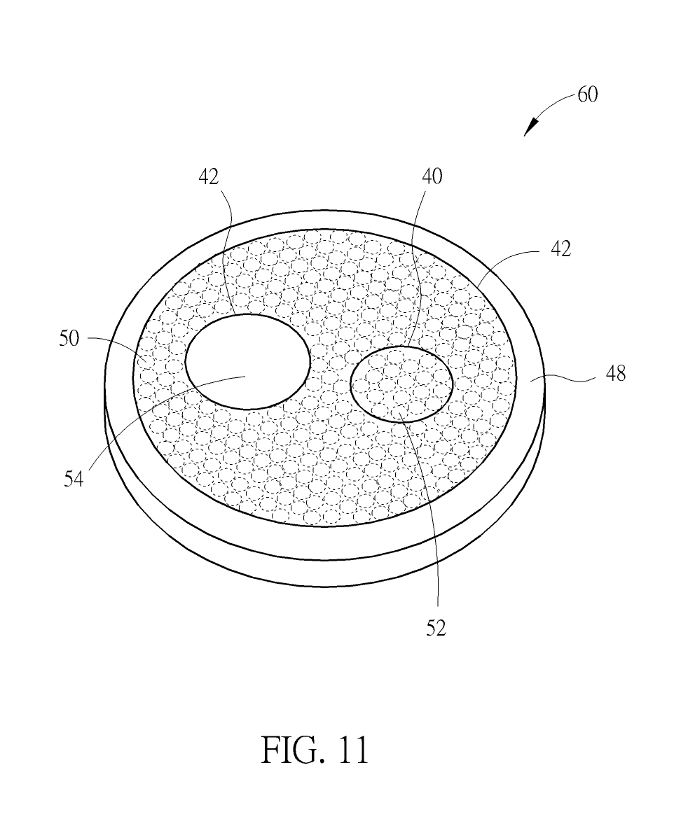

Please refer to FIG. 5 to FIG. 11. FIG. 5 is a flow chart illustrating method for manufacturing the lens 38 with the first transparent portion 40 and the second transparent portion 42 as well as the opaque portion 44 according to the embodiment of the present invention. FIG. 6 to FIG. 11 are respectively a schematic diagram illustrating how to manufacturing the lens 38 corresponding to the steps shown in FIG. 5. As shown in FIG. 5, the method includes steps of:

Step 100 Bundle a plurality of first glass fibers 50 doped with metallic ions with at least two second glass fibers 52,54 to form a bundled glass fiber 56.

Step 102 Heat the bundled glass fiber 56 for forming a glass piece 58.

Step 104 Slice the glass piece 58 into a plurality of glass disks 60.

Step 106 Dispose the plurality of glass disks 60 in a heating chamber 66.

Step 108 Heat the plurality of glass disks 60 in the heating chamber 66 to reduce the metallic ions in the glass disks 60 to metallic atoms so that the opaque portion 44 is formed with doping of metallic atoms to absorb the light.

Step 110 End.

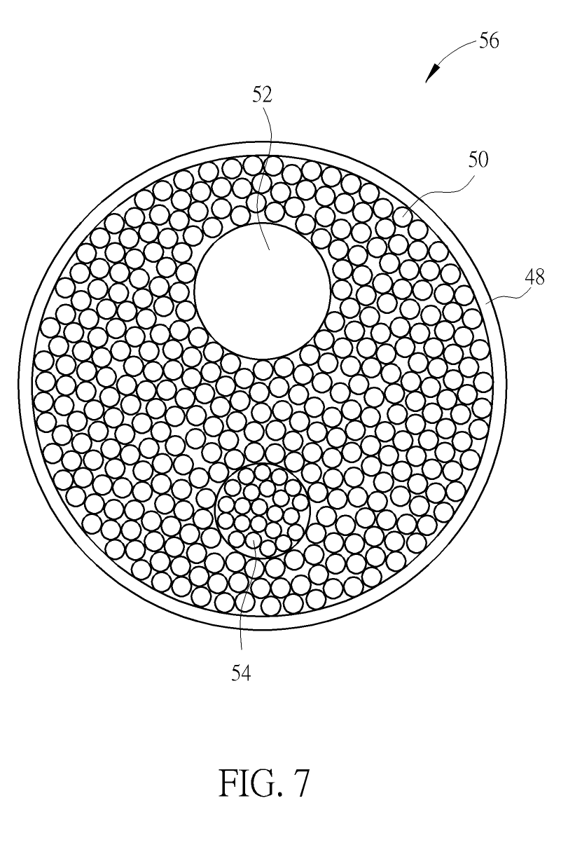

Detailed descriptions for how to form the first transparent portion 40 and the second transparent portion 42 within the opaque portion 44 of the lens 38 is provided as follows. First, bundle a plurality of first glass fibers 50 doped with metallic ions with at least two of second glass fibers 52,54 to form the bundled glass fiber 56 (Step 100). There are two methods to bundle up the glass fibers. The first method is by using a hollow cylinder 48. As shown in FIG. 6 and FIG. 7, the plurality of first glass fibers 50 and at least two second glass fibers 52,54 disposed inside the hollow cylinder 48 to form the bundled glass fiber 56. It should be noticed that the first glass fibers 50 is doped with metallic ions such as lead ions and the second glass fibers 52,54 are not doped with the metallic ions. After the aforesaid process is completed, the plurality of first glass fibers 50 doped with the lead ions is bundled inside the hollow cylinder 48, the second glass fibers 52,54 is disposed within the plurality of first glass fibers 50 inside the hollow cylinder 48, and the plurality of second glass fibers 52,54 is bundled within the plurality of first glass fibers 50 inside the hollow cylinder 48, as shown in FIG. 6 and FIG. 7.

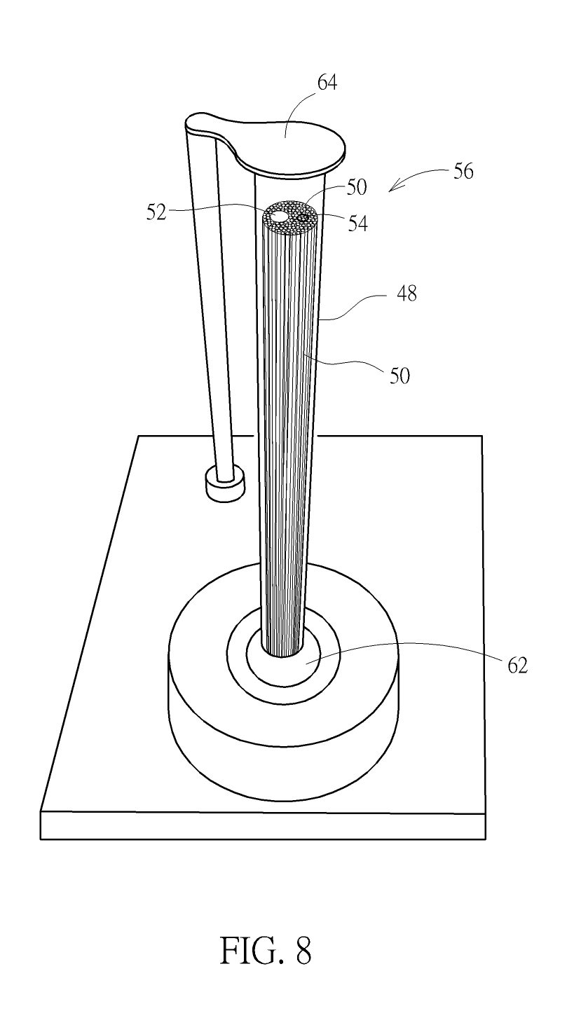

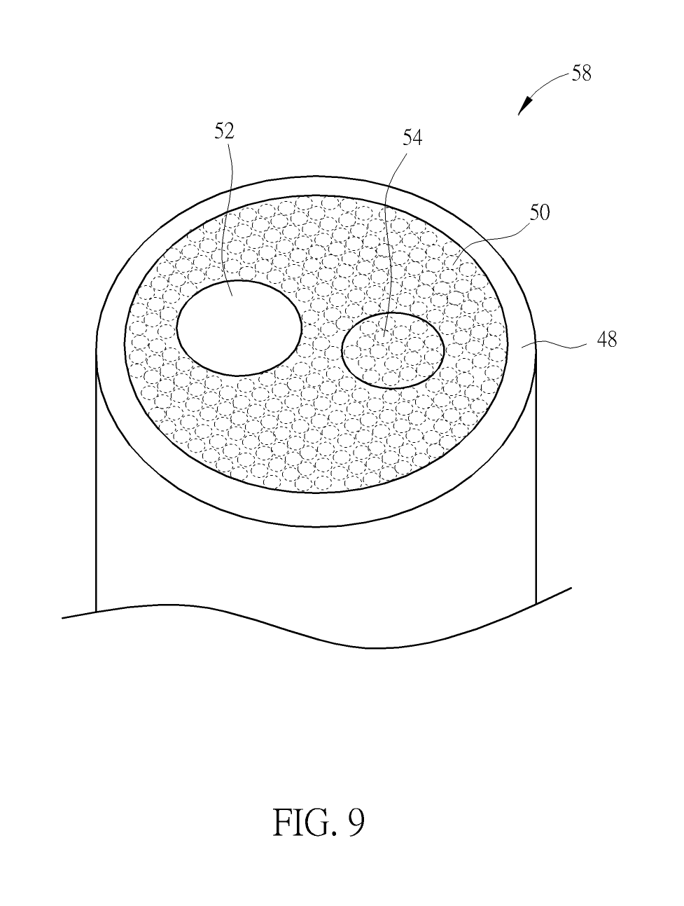

Next, the bundled glass fiber 56 are heated to form a glass piece 58 (Step 102). At this stage, the bundled glass fiber 56 may be drawn or heated to form the glass piece 58. More detailed description for the drawn or heated process is illustrated with FIG. 8 and FIG. 9 as follows. The bundled glass fiber 56 of the hollow cylinder 48 filled with the plurality of first glass fibers 50 and the second glass fibers 52,54 is placed onto a jig 64, and an end of the bundled glass fiber 56 can be clamped on the jig 64, so that the bundled glass fiber 56 can be supported vertically. Then, put the other end of the bundled glass fiber 56 on the furnace 62 to heat section of the bundled glass fiber 56 to approximate 1000° C. At the meantime, the plurality of first glass fibers 50 and the second glass fibers 52,54 bundled inside the hollow cylinder 48 are softened and melted as a whole, so as to form the glass piece 58, as shown in FIG. 9. The glass piece 58 may be a rod or block that contains the non leaded glass and leaded glass.

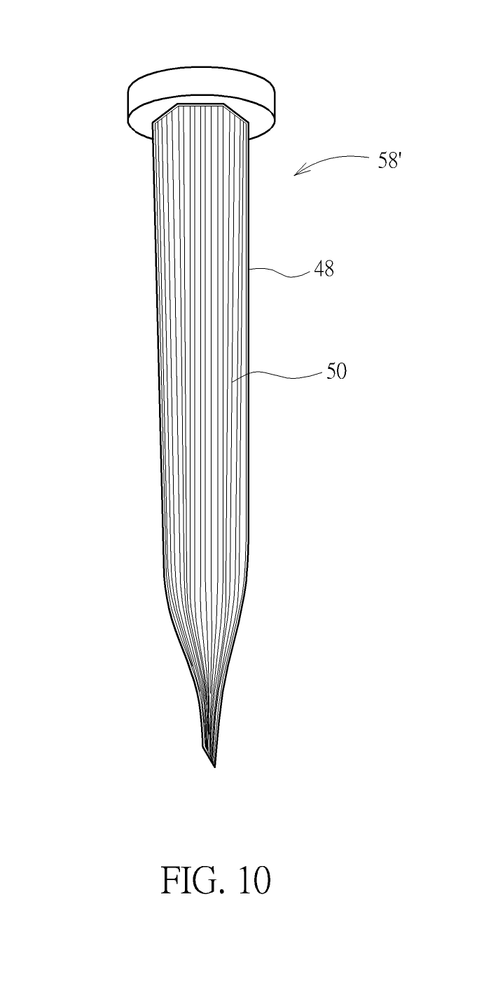

During the process that the first glass fibers 50 and the second glass fibers 52,54 bundled inside the hollow cylinder 48 are softened and melted to form the glass piece 58, draw the glass piece 58 to form a drawn glass piece 58′ shown in FIG. 10, and then cool the drawn glass piece 58′. After the drawn glass piece 58′ is cooled, slice the drawn glass piece 58′ shown in FIG. 10 into a plurality of glass disks 60, wherein of the glass disks 60 are respectively shown as FIG. 10 (Step 104). Since the drawn glass piece 58′ shown in FIG. 10 is formed by drawing process, cross sections vary along the drawn glass piece 58′. Therefore, the glass disks 60 formed by slicing the drawn glass piece 58′ varies in diameter for different electronic device. The CNC (computer numerical control) machining may be used to slice the drawn glass piece 58′ to the plurality of glass disks 60. The CNC machining is an automation of machine tools that are operated by abstractly programmed commands encoded on a storage medium, as opposed to controlled manually via handwheels or levers, or mechanically automated via cams alone. In a CNC systems, end-to-end component design is highly automated using computer-aided design (CAD) and computer-aided manufacturing (CAM) programs. The programs produce a computer file that is interpreted to extract the commands needed to operate a particular machine via a postprocessor, and then loaded into the CNC machines for production.

As mentioned above, the plurality of first glass fibers 50 is used for forming the opaque portion 44 when the hollow cylinder 48 with the plurality of first glass fibers 50 is melted, drawn and machined. The second glass fiber 54 is used for forming the second transparent portion 42 for covering the light sensor 36 when the hollow cylinder 48 with the plurality of first glass fibers 50 and the second glass fibers 54 are melted, drawn and machined. The second glass fiber 52 is used for forming the first transparent portion 40 for covering the light emitting module 34 when the hollow cylinder 48 with the plurality of first glass fibers 50 and second glass fiber 52 are melted, drawn and machined. Since the light sensor 36 captures the light or senses the light reflected by an object through second transparent portion 42, the second transparent portion 42 requires a better transparency for enhancing quality of images. In this embodiment, the second glass fiber 52 may include a plurality of glass fibers, and the second glass fiber 54 may be a single glass fiber.

Next, in Step 106, the glass disks 60 are disposed in a heating chamber, not shown in figures. The glass disks 60 may be placed in the heating chamber with a space between the two adjacent glass disks 60. After placing the glass disks 60 in the heating chamber, heats the plurality of glass disks 60 in the heating chamber to reduce the metallic ions in the glass disks 60 to metallic atoms, so that the opaque portion 44 is formed with metallic atoms doped for absorbing the light. The temperature of the heating chamber may range between 460 degree Celsius and 1600 degree Celsius. In other word, the glass disks 60 are heated to a temperature between 460 degree Celsius and 1600 degree Celsius. Furthermore, the glass disks 60 may be placed in the heating chamber for at least 8 hours.

The hydrogen gas may be introduced in the heating chamber at rate of at least 4 cubic feet per hour for hydrogen firing process, i.e. the lead ions doped in the opaque portion 44 is reduced to the lead atoms in a hydrogen firing process. Accordingly, the lead atoms turn the opaque portion 44 to be opaque for absorbing the light emitted from the light emitting module 34. The afterward process may comprise polishing the glass disks 60 after heating the plurality of glass disks 60 in the heating chamber. The glass disks 60 may also coated an anti-reflective coating 46 on the plurality of glass disks 60 after heating the plurality of glass disks 60 in the heating chamber or after polishing the glass disks 60.

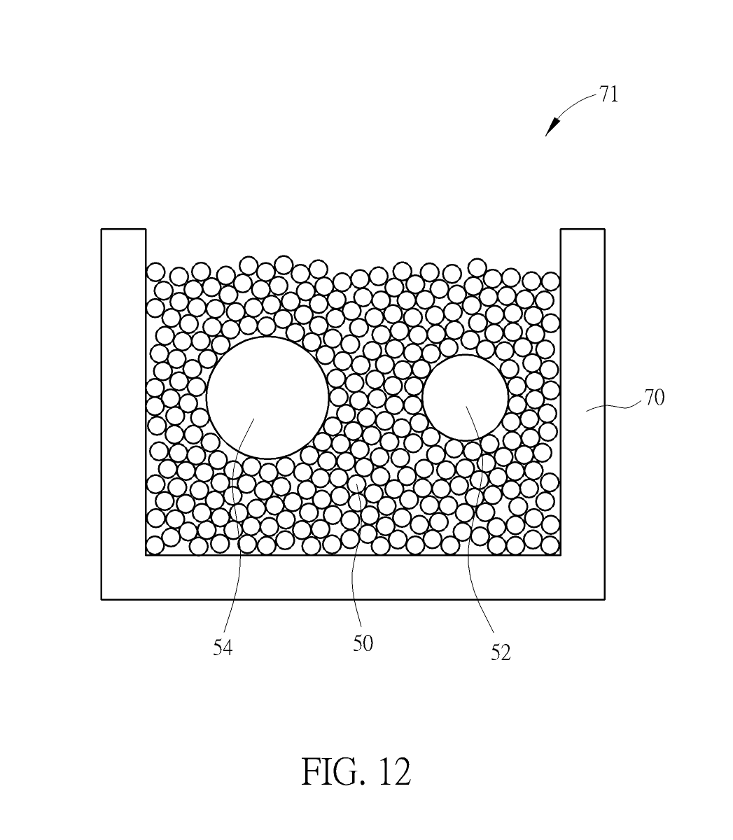

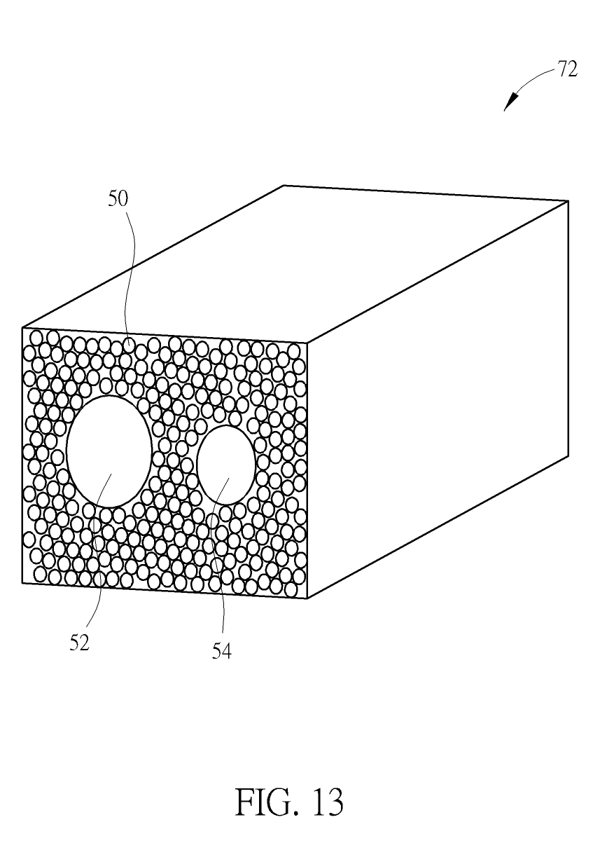

Please refer to FIGS. 12, and 13. The second method to bundle a plurality of first glass fibers 50 doped with metallic ions with at least two of second glass fibers 52, 54 to form a bundled glass fiber is to use a container 70. A bundled glass fiber 71 may be formed by placing the plurality of first glass fibers 50 and at least two of second glass fibers 52, 54 disposed in a container 70 or a fixture to form the bundled glass fiber 71. The first glass fibers 50 may be doped with metallic ions such as lead ions and the second glass fibers 52, 54 are not doped with the metallic ions. After the aforesaid process is completed, the plurality of first glass fibers 50 doped with the lead ions are bundled in the container 70, the second glass fibers 52,54 are disposed within the plurality of first glass fibers 50 in the container 70, as shown in FIG. 12. After the container 70 is filled with the plurality of first glass fibers 50 and the second glass fibers 52,54, heat and soften the container 70 to melt the plurality of first glass fibers 50 and the second glass fibers 52,54 as a whole, so as to form a glass piece 72, as shown in FIG. 13.

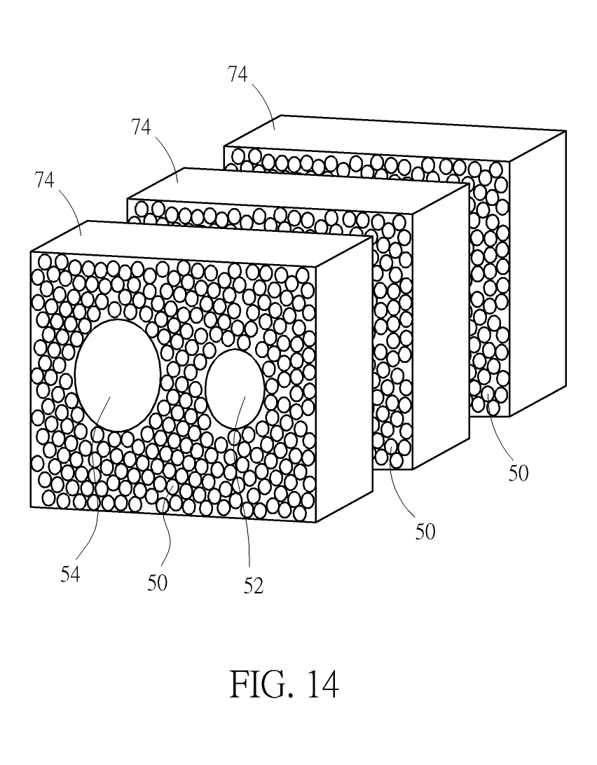

As shown in FIG. 14, the glass piece 72 may be sliced into to a plurality of glass disks 74, wherein the glass disks may be rectangular. Then, fire the plurality of glass disks 74 in a hydrogen firing process. After the firing process is completed, the glass disks 74 may be polished or machining processed to a circular shape. The glass piece 72 with rectangular shape may be polished or machining processed to a circular shape to form a rod structure or block structure, and then the rod structure and the block structure are sliced into a plurality of glass disks. After the glass piece is machining processed to a circular shape and sliced to the plurality of glass disks, the glass disks may be polished and then placed in the heating chamber for hydrogen firing process as previous described.

Compared to the prior art, since the first transparent portion, the second transparent portion and the opaque portion of the lens member are integrally formed by the first glass fibers with metallic ions doped and the second glass fibers in a firing process, the lens of the present invention can have a smooth and single surface. In addition, the metallic ions, i.e. the lead ions, doped in first glass fibers are reduced to the metallic atoms, i.e. the lead atoms, for opaque the light instead of the conventionally printed ink. Thus, it is more scratch resistant, i.e. the lens of present invention provides a lens structure with light leakage prevention as well as a smooth and single surface that is scratch resistant.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a housing;
a light emitting module disposed inside the housing and configured to emit a light out of the housing;
a light sensor disposed inside the housing and configured to receive an environmental light outside the housing; and
a lens coupled with the housing, comprising:
a first transparent portion through which the light passes and is emitted out of the housing;
a second transparent portion through which the environmental light outside the housing passes and is received by the light sensor; and
an opaque portion disposed between the first transparent portion and the second transparent portion, wherein the first transparent portion, the second transparent portion and the opaque portion are integrated into a whole and made of the same material.

2. The electronic device of claim 1, wherein an opening is formed on the housing, and the lens is disposed in the opening.

3. The electronic device of claim 1, wherein an aperture is formed on the housing, and the lens is disposed between the aperture and the light sensor.

4. The electronic device of claim 1, wherein the opaque portion is doped with metallic atoms for absorbing the light transmitted to the opaque portion.

5. The electronic device of claim 4, wherein the metallic atoms are products of a reduction of a portion of metallic ions doped in the opaque portion.

6. The electronic device of claim 5, wherein the metallic ions are reduced to metallic atoms in a hydrogen firing process.

7. The electronic device of claim 4, wherein the metallic atoms are lead atoms.

8. The electronic device of claim 4, wherein doping percentage of the metallic atoms arranges from 24 percent to 35 percent.

9. The electronic device of claim 1, wherein the opaque portion, the first transparent portion and the second transparent portion are circular structures, a diameter of the second transparent portion is greater than a diameter of the first transparent portion, and the first transparent portion and the second transparent portion are disposed within the opaque portion.

10. The electronic device of claim 1, wherein the first transparent portion, the second transparent portion and the opaque portion are made of silica materials.

11. The electronic device of claim 1, wherein the lens further comprises an anti-reflective coating disposed on the lens.

12. The electronic device of claim 11, wherein the anti-reflective coating is disposed between the lens and the light emitting module and the light sensor.

13. The electronic device of claim 1, wherein the light sensor is an image sensor.

14. The electronic device of claim 1, wherein the first transparent portion overlays the light emitting module.

15. The electronic device of claim 1, wherein the second transparent portion overlays the light sensor.

16. A method for manufacturing a lens with at least two transparent portions and an opaque portion, the method comprising:
bundling a plurality of first glass fibers doped with metallic ions with at least two of second glass fibers to form a bundled glass fiber;
heating the bundled glass fiber for forming a glass piece;
slicing the glass piece into a plurality of glass disks;
disposing the plurality of glass disks in a heating chamber;
heating the plurality of glass disks in the heating chamber to reduce the metallic ions in the glass disks to metallic atoms, so that the opaque portion with the metallic atoms doped is formed for absorbing a light.

17. The method of claim 16, wherein bundling a plurality of first glass fibers doped with metallic ions with at least two of second glass fibers to form a bundled glass fiber further comprises:
providing a hollow cylinder;
disposing the plurality of first glass fibers inside the hollow cylinder; and
disposing the at least two of second glass fibers inside the hollow cylinder to form the bundled glass fiber.

18. The method of claim 16, wherein heating the bundled glass fiber for forming a glass piece further comprises:
melting the bundled glass fiber; and
drawing the bundled glass fiber for forming the glass piece.

19. The method of claim 16, wherein bundling a plurality of first glass fibers doped with metallic ions with at least two of second glass fibers to form a bundled glass fiber further comprises:
providing a container;
disposing the plurality of first glass fibers and at least two of second glass fibers inside the container for forming the bundled glass fiber.

20. The method of claim 19, wherein heating the bundled glass fiber for forming a glass piece further comprises:
heating the container; and
melting the first glass fibers to form the glass piece.

21. The method of claim 16, wherein disposing the plurality of glass disks in a heating chamber further comprises placing the glass disks in the heating chamber with a space between the two adjacent glass disks.

22. The method of claim 16, wherein heating the plurality of glass disks comprises heating the plurality of glass disks at a temperature between 460 degree Celsius and 1600 degree Celsius.

23. The method of claim 16, wherein heating the plurality of glass disks comprises the plurality of glass disks is heated for at least 8 hours.

24. The method of claim 16, wherein heating the plurality of glass disks to reduce the metallic ions in the glass disks to metallic atoms in a heating chamber further comprises flowing hydrogen gas in the heating chamber.

25. The method of claim 24, wherein flow rate of hydrogen gas in the heating chamber is at least 4 cubic feet per hour.

26. The method of claim 16, further comprising polishing the plurality of glass disks after heating the plurality of glass disks in the heating chamber.

27. The method of claim 16, further comprising coating anti-reflective coating on the plurality of glass disks after heating the plurality of glass disks in the heating chamber.
